(19) United States
(12) Patent Application Publication
(10) Pub. No.: US 2026/0206037 A1
(43) Pub. Date: Jul. 16, 2026

(54) TECHNIQUES FOR PHYSICAL SIDELINK FEEDBACK CHANNEL MULTIPLEXING

(71) Applicant: QUALCOMM INCORPORATED, San Diego, CA (US)

(72) Inventors: Chih-Hao LIU, San Diego, CA (US); Jing SUN, San Diego, CA (US); Xiaoxia ZHANG, San Diego, CA (US); Juan MONTOJO, San Diego, CA (US); Giovanni CHISCI, San Diego, CA (US); Stelios STEFANATOS, San Diego, CA (US)

(21) Appl. No.: 19/134,015

(22) PCT Filed: Dec. 27, 2023
(86) PCT No.: PCT/US2023/086066

§ 371 Date: May 29, 2025

(30) Foreign Application Priority Data
Feb. 2, 2023 (GR) 20230100081

(51) Int. Cl. H04W 72/25

(52) U.S. Cl. CPC H04W 72/25

(57) ABSTRACT

Various aspects of the present disclosure generally relate to wireless communication. In sone aspects, a user equipment (UE) may receive configuration information that indicates a number of interleaved resource blocks to be used by a plurality of physical sidelink feedback channel (PSFCH) resources, the plurality of PSFCH resources including at least a first PSFCH resource that occupies a first number of interleaved resource blocks within an interlace and a second PSFCH resource that occupies a second number of interleaved resource blocks within the interlace, the first number of interleaved resource blocks and the second number of interleaved resource blocks being contiguous or configured in accordance with an interval. The UE may transmit a PSFCH communication via at least one of the first PSFCH resource or the second PSFCH resource. Numerous other aspects are described.

### CROSS-REFERENCE TO RELATED APPLICATION

This patent application claims priority to Greek Nonprovisional Patent Application No. 20230100081, filed on Feb. 2, 2023, entitled “TECHNIQUES FOR PHYSICAL SIDELINK FEEDBACK CHANNEL MULTIPLEXING,” which is hereby expressly incorporated by reference herein.

### FIELD OF THE DISCLOSURE

Aspects of the present disclosure generally relate to wireless communication and to techniques and apparatuses for physical sidelink feedback channel multiplexing.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a method of wireless communication performed by a user equipment (UE). The method may include receiving configuration information that indicates a number of interleaved resource blocks to be used by a plurality of physical sidelink feedback channel (PSFCH) resources, the plurality of PSFCH resources including at least a first PSFCH resource that occupies a first number of interleaved resource blocks within an interlace and a second PSFCH resource that occupies a second number of interleaved resource blocks within the interlace, the first number of interleaved resource blocks and the second number of interleaved resource blocks being contiguous or configured in accordance with an interval. The method may include transmitting a PSFCH communication via at least one of the first PSFCH resource or the second PSFCH resource.

Some aspects described herein relate to a method of wireless communication performed by a network node. The method may include identifying a number of interleaved resource blocks to be used by a plurality of PSFCH resources, the plurality of PSFCH resources including at least a first PSFCH resource that occupies a first number of interleaved resource blocks within an interlace and a second PSFCH resource that occupies a second number of interleaved resource blocks within the interlace, the first number of interleaved resource blocks and the second number of interleaved resource blocks being contiguous or configured in accordance with an interval. The method may include transmitting configuration information that indicates the number of interleaved resource blocks to be used by the plurality of PSFCH resources.

Some aspects described herein relate to an apparatus for wireless communication at a UE. The apparatus may include a memory and one or more processors coupled to the memory. The one or more processors may be configured to receive configuration information that indicates a number of interleaved resource blocks to be used by a plurality of PSFCH resources, the plurality of PSFCH resources including at least a first PSFCH resource that occupies a first number of interleaved resource blocks within an interlace and a second PSFCH resource that occupies a second number of interleaved resource blocks within the interlace, the first number of interleaved resource blocks and the second number of interleaved resource blocks being contiguous or configured in accordance with an interval. The one or more processors may be configured to transmit a PSFCH communication via at least one of the first PSFCH resource or the second PSFCH resource.

Some aspects described herein relate to an apparatus for wireless communication at a network node. The apparatus may include a memory and one or more processors coupled to the memory. The one or more processors may be configured to identify a number of interleaved resource blocks to be used by a plurality of PSFCH resources, the plurality of PSFCH resources including at least a first PSFCH resource that occupies a first number of interleaved resource blocks within an interlace and a second PSFCH resource that occupies a second number of interleaved resource blocks within the interlace, the first number of interleaved resource blocks and the second number of interleaved resource blocks being contiguous or configured in accordance with an interval. The one or more processors may be configured to transmit configuration information that indicates the number of interleaved resource blocks to be used by the plurality of PSFCH resources.

Some aspects described herein relate to a non-transitory computer-readable medium that stores a set of instructions for wireless communication by a UE. The set of instructions, when executed by one or more processors of the UE, may cause the UE to receive configuration information that indicates a number of interleaved resource blocks to be used by a plurality of PSFCH resources, the plurality of PSFCH resources including at least a first PSFCH resource that occupies a first number of interleaved resource blocks within an interlace and a second PSFCH resource that occupies a second number of interleaved resource blocks within the interlace, the first number of interleaved resource blocks and the second number of interleaved resource blocks being contiguous or configured in accordance with an interval. The set of instructions, when executed by one or more processors of the UE, may cause the UE to transmit a PSFCH communication via at least one of the first PSFCH resource or the second PSFCH resource.

Some aspects described hemin relate to a non-transitory computer-readable medium that stores a set of instructions for wireless communication by a network node. The set of instructions, when executed by one or more processors of the network node, may cause the network node to identify a number of interleaved resource blocks to be used by a plurality of PSFCH resources, the plurality of PSFCH resources including at least a first PSFCH resource that occupies a first number of interleaved resource blocks within an interlace and a second PSFCH resource that occupies a second number of interleaved resource blocks within the interlace, the first number of interleaved resource blocks and the second number of interleaved resource blocks being contiguous or configured in accordance with an interval. The set of instructions, when executed by one or more processors of the network node, may cause the network node to transmit configuration information that indicates the number of interleaved resource blocks to be used by the plurality of PSFCH resources.

Some aspects described herein relate to an apparatus for wireless communication. The apparatus may include means for receiving configuration information that indicates a number of interleaved resource blocks to be used by a plurality of PSFCH resources, the plurality of PSFCH resources including at least a first PSFCH resource that occupies a first number of interleaved resource blocks within an interlace and a second PSFCH resource that occupies a second number of interleaved resource blocks within the interlace, the first number of interleaved resource blocks and the second number of interleaved resource blocks being contiguous or configured in accordance with an interval. The apparatus may include means for transmitting a PSFCH communication via at least one of the first PSFCH resource or the second PSFCH resource.

Some aspects described herein relate to an apparatus for wireless communication. The apparatus may include means for identifying a number of interleaved resource blocks to be used by a plurality of PSFCH resources, the plurality of PSFCH resources including at least a first PSFCH resource that occupies a first number of interleaved resource blocks within an interlace and a second PSFCH resource that occupies a second number of interleaved resource blocks within the interlace, the first number of interleaved resource blocks and the second number of interleaved resource blocks being contiguous or configured in accordance with an interval. The apparatus may include means for transmitting configuration information that indicates the number of interleaved resource blocks to be used by the plurality of PSFCH resources.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example of a network node in communication with a user equipment (UE) in a wireless network.

FIG. 3 is a diagram illustrating an example disaggregated base station architecture, in accordance with the present disclosure.

FIG. 4 is a diagram illustrating an example of sidelink communications, in accordance with the present disclosure.

FIG. 5 is a diagram illustrating an example of sidelink communications and access link communications, in accordance with the present disclosure.

FIG. 6 is a diagram illustrating an example of a physical sidelink feedback channel, in accordance with the present disclosure.

FIG. 7 is a diagram illustrating examples of single-bit and multiple-bit physical sidelink feedback channel multiplexing, in accordance with the present disclosure.

FIGS. 8A-8B are diagrams illustrating examples of physical sidelink feedback channel and interlace transmissions, in accordance with the present disclosure.

FIG. 9 is a diagram illustrating an example of physical sidelink feedback channel multiplexing, in accordance with the present disclosure.

FIG. 10 is a diagram illustrating examples of partial interlace configurations for physical sidelink feedback channel communications, in accordance with the present disclosure.

FIG. 11 is a diagram illustrating an example of partial interlace physical sidelink feedback channel frequency division multiplexing, in accordance with the present disclosure.

FIG. 12 is a diagram illustrating an example of partial interlace transmission and dropping, in accordance with the present disclosure.

FIG. 13 is a diagram illustrating an example process performed, for example, by a UE, in accordance with the present disclosure.

FIG. 14 is a diagram illustrating an example process performed, for example, by a network node, in accordance with the present disclosure.

FIG. 15 is a diagram of an example apparatus for wireless communication, in accordance with the present disclosure.

FIG. 16 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

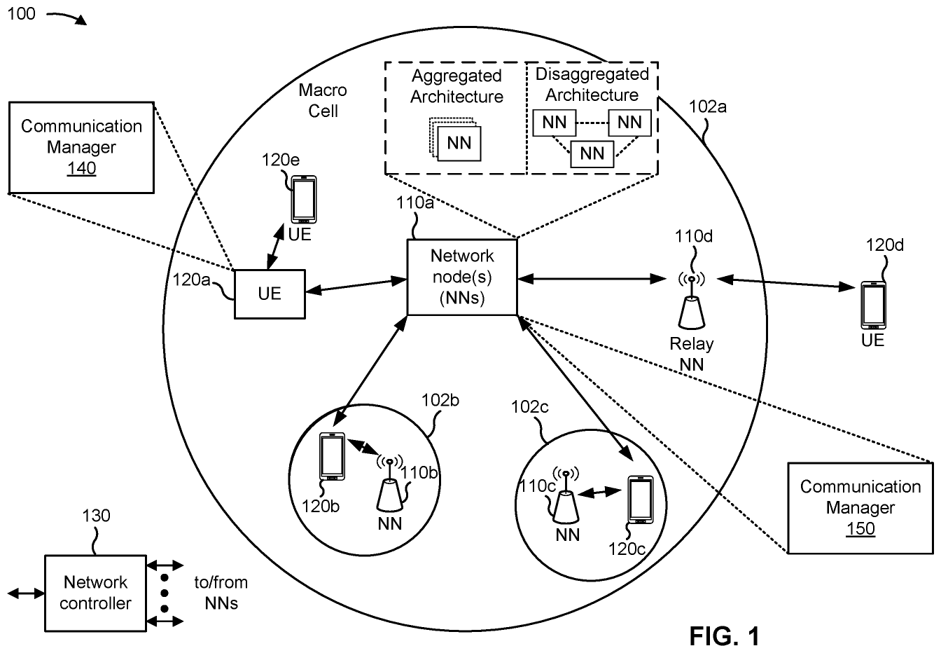

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs. and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or“network node” may refer to an aggregated base station, a disaggregated base station, an integrated access and backhaul (TAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support an RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz). FR4 (52.6 GHz-114.25 GHz), and FR5 (114.25 GHz-300 GHz). Each of these higher frequency bands falls within the EHF band.

With these examples in mind, unless specifically stated otherwise, the term “sub-4 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2. FR4, FR4-a or FR4-1, or FR5, or may be within the EHF band. It is contemplated that the frequencies included in these operating bands (for example, FR1, FR2, FR3, FR4. FR4-a. FR4-1, or FR5) may be modified, and techniques described herein are applicable to those modified frequency ranges.

In some aspects, the UE 120 may include a communication manager 140. As described in more detail elsewhere herein, the communication manager 140 may receive configuration information that indicates a number of interleaved resource blocks to be used by a plurality of PSFCH resources, the plurality of PSFCH resources including at least a first PSFCH resource that occupies a first number of interleaved resource blocks within an interlace and a second PSFCH resource that occupies a second number of interleaved resource blocks within the interlace, the first number of interleaved resource blocks and the second number of interleaved resource blocks being contiguous or configured in accordance with an interval; and transmit a PSFCH communication via at least one of the first PSFCH resource or the second PSFCH resource. Additionally. or alternatively, the communication manager 140 may perform one or more other operations described herein.

In some aspects, the network node 110 may include a communication manager 150. As described in more detail elsewhere herein, the communication manager 150 may identify a number of interleaved resource blocks to be used by a plurality of PSFCH resources, the plurality of PSFCH resources including at least a first PSFCH resource that occupies a first number of interleaved resource blocks within an interlace and a second PSFCH resource that occupies a second number of interleaved resource blocks within the interface, the first number of interleaved resource blocks and the second number of interleaved resource blocks being contiguous or configured in accordance with an interval; and transmit configuration information that indicates the number of interleaved resource blocks to be used by the plurality of PSFCH resources. Additionally. or alternatively, the communication manager 150 may perform one or more other operations described herein.

As indicated above, FIG. 1 is provided as an example. Other examples may differ from what is described with regard to FIG. 1.

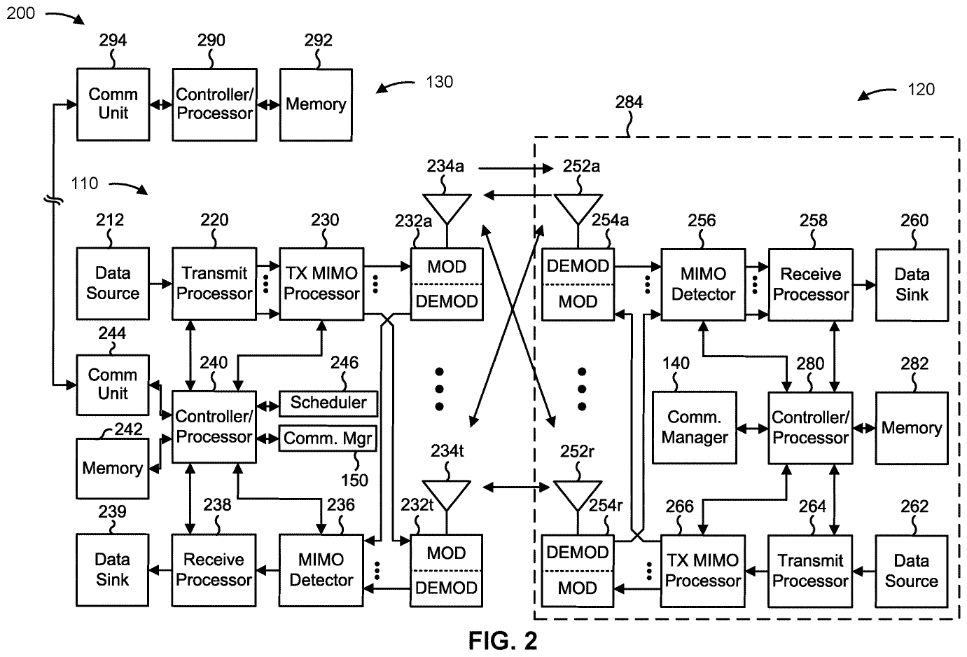

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

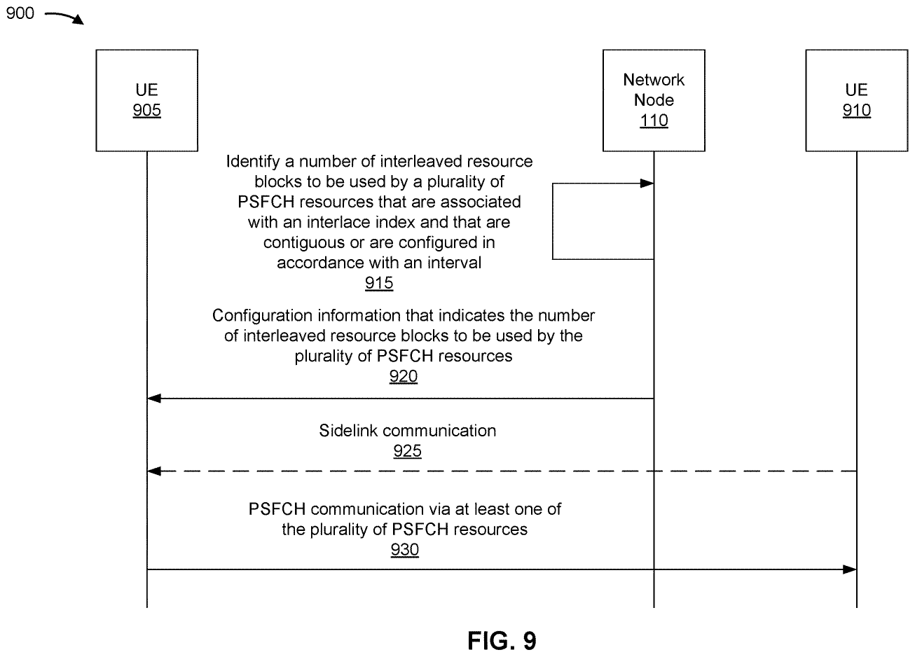

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 9-16).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 9-16).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

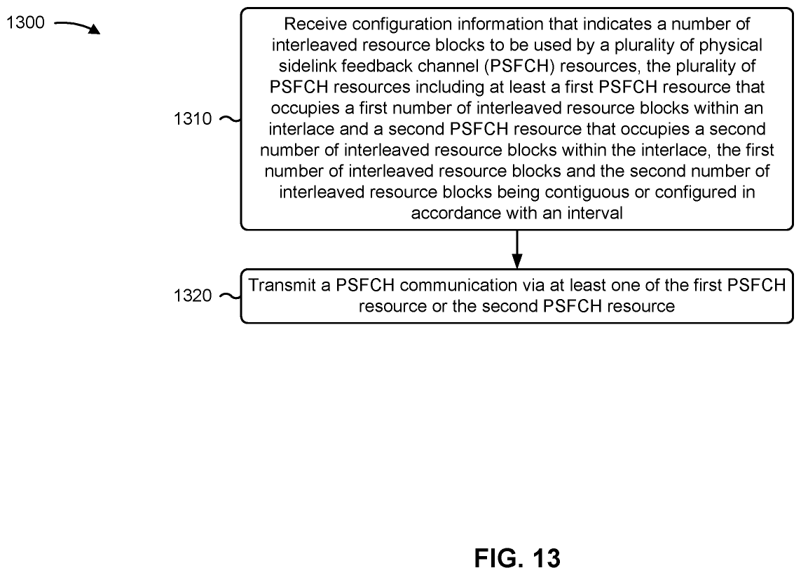

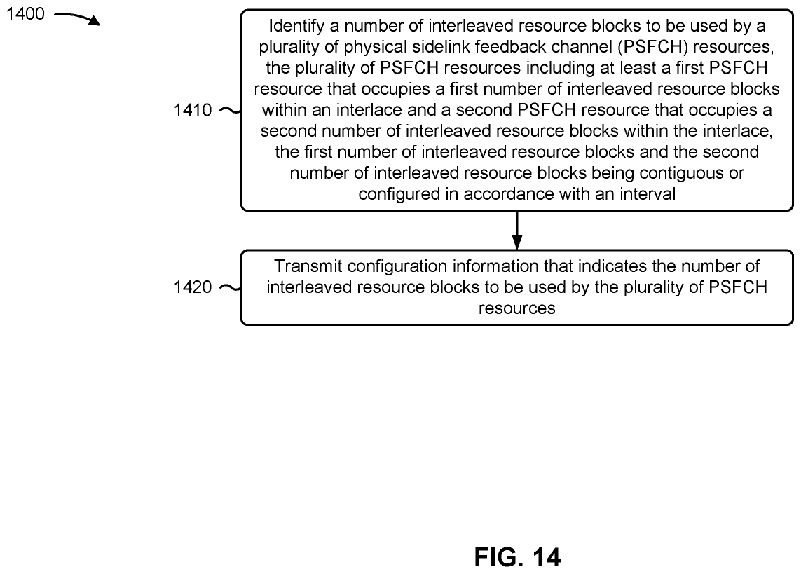

The controller/processor 240 of the network node 110, the controller/processor 280 of the UE 120, or any other component(s) of FIG. 2 may perform one or more techniques associated with PSFCH multiplexing, as described in more detail elsewhere herein. For example, the controller/processor 240 of the network node 110, the controller/processor 280 of the UE 120, or any other component(s) (or combinations of components) of FIG. 2 may perform or direct operations of, for example, process 1300 of FIG. 13, process 1400 of FIG. 14, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 1300 of FIG. 13, process 1400 of FIG. 14, and/or other processes as described herein. In some examples, executing instructions may include running the instructions, converting the instructions, compiling the instructions, and/or interpreting the instructions, among other examples.

In some aspects, the UE includes means for receiving configuration information that indicates a number of interleaved resource blocks to be used by a plurality of PSFCH resources, the plurality of PSFCH resources including at least a first PSFCH resource that occupies a first number of interleaved resource blocks within an interlace and a second PSFCH resource that occupies a second number of interleaved resource blocks within the interlace, the first number of interleaved resource blocks and the second number of interleaved resource blocks being contiguous or configured in accordance with an interval; and/or means for transmitting a PSFCH communication via at least one of the first PSFCH resource or the second PSFCH resource. The means for the UE to perform operations described herein may include, for example, one or more of communication manager 140, antenna 252, modem 254, MIMO detector 256, receive processor 258, transmit processor 264. TX MIMO processor 266, controller/processor 280, or memory 282.

In some aspects, the network node includes means for identifying a number of interleaved resource blocks to be used by a plurality of PSFCH resources, the plurality of PSFCH resources including at least a first PSFCH resource that occupies a first number of interleaved resource blocks within an interlace and a second PSFCH resource that occupies a second number of interleaved resource blocks within the interlace, the first number of interleaved resource blocks and the second number of interleaved resource blocks being contiguous or configured in accordance with an interval; and/or means for transmitting configuration information that indicates the number of interleaved resource blocks to be used by the plurality of PSFCH resources. The means for the network node to perform operations described herein may include, for example, one or more of communication manager 150, transmit processor 220. TX MIMO processor 230, modem 232, antenna 234. MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above. FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs. or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

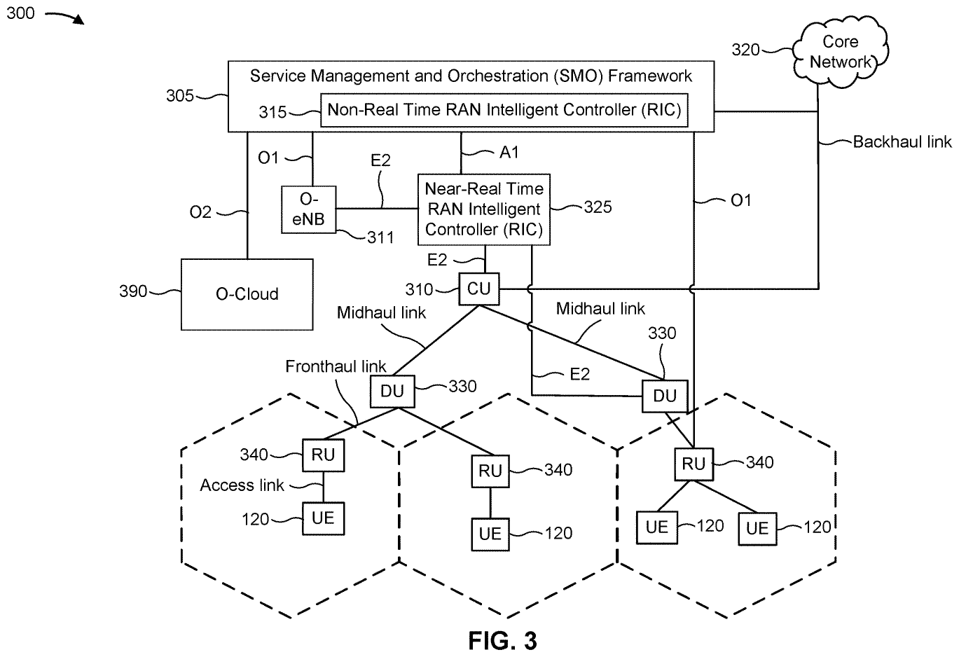

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example. Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310. DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

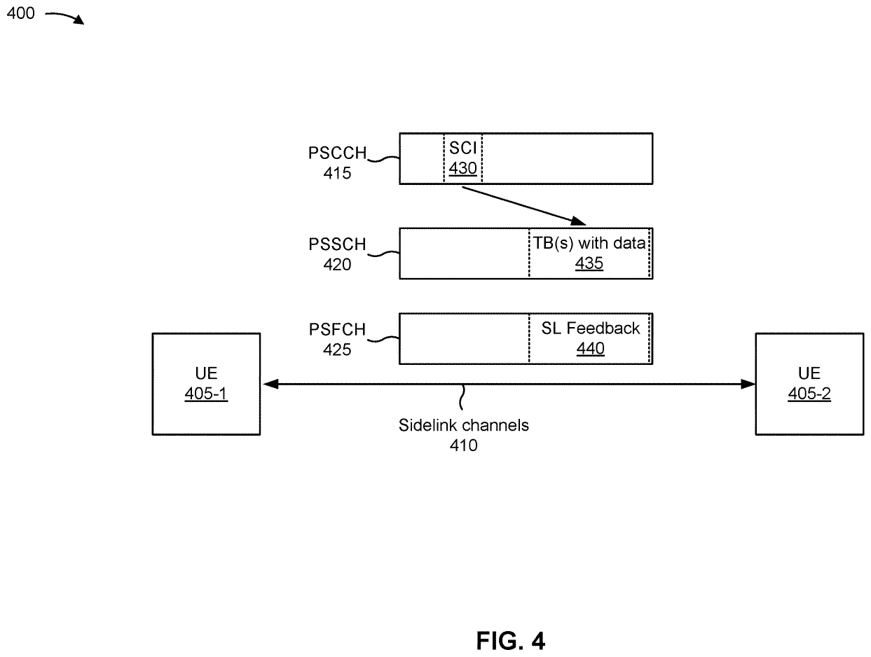

FIG. 4 is a diagram illustrating an example 400 of sidelink communications, in accordance with the present disclosure.

As shown in FIG. 4, a first UE 405-1 may communicate with a second UE 405-2 (and one or more other UEs 405) via one or more sidelink channels 410. The UEs 405-1 and 405-2 may communicate using the one or more sidelink channels 410 for P2P communications, D2D communications, V2X communications (e.g., which may include V2V communications. V2I communications, and/or V2P communications) and/or mesh networking. In some aspects, the UEs 405 (e.g., UE 405-1 and/or UE 405-2) may correspond to one or more other UEs described elsewhere herein, such as UE 120. In some aspects, the one or more sidelink channels 410 may use a PC5 interface and/or may operate in a high frequency band (e.g., the 5.9 GHz band). Additionally, or alternatively, the UEs 405 may synchronize timing of transmission time intervals (TTIs) (e.g., frames, subframes, slots, or symbols) using global navigation satellite system (GNSS) timing.

As further shown in FIG. 4, the one or more sidelink channels 410 may include a physical sidelink control channel (PSCCH) 415, a physical sidelink shared channel (PSSCH) 420, and/or a physical sidelink feedback channel (PSFCH) 425. The PSCCH 415 may be used to communicate control information, similar to a physical downlink control channel (PDCCH) and/or a physical uplink control channel (PUCCH) used for cellular communications with a network node 110 via an access link or an access channel. The PSSCH 420 may be used to communicate data, similar to a physical downlink shared channel (PDSCH) and/or a physical uplink shared channel (PUSCH) used for cellular communications with a network node 110 via an access link or an access channel. For example, the PSCCH 415 may carry sidelink control information (SCI) 430, which may indicate various control information used for sidelink communications, such as one or more resources (e.g., time resources, frequency resources, and/or spatial resources) where a transport block (TB) 435 may be carried on the PSSCH 420. The TB 435 may include data. The PSFCH 425 may be used to communicate sidelink feedback 440, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 415, in some aspects, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, for example, an indication of one or more resources (e.g., time resources, frequency resources, and/or spatial resources) on the PSSCH 420, information for decoding sidelink communications on the PSSCH, a quality of service (QoS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 420, such as a hybrid automatic repeat request (HARQ) process ID, a new data indicator (NDI), a source identifier, a destination identifier, and/or a channel state information (CST) report trigger.

In some aspects, the one or more sidelink channels 410 may use resource pools. For example, a scheduling assignment (e.g., included in SCI 430) may be transmitted in sub-channels using specific resource blocks (RBs) across time. In some aspects, data transmissions (e.g., on the PSSCH 420) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 405 may operate using a sidelink transmission mode (e.g., Mode 1) where resource selection and/or scheduling is performed by a network node 110 (e.g., a base station, a CU, or a DU). For example, the UE 405 may receive a grant (e.g., in downlink control information (DCI) or in an RRC message, such as for configured grants) from the network node 110 (e.g., directly or via one or more network nodes) for sidelink channel access and/or scheduling. In some aspects, a UE 405 may operate using a transmission mode (e.g., Mode 2) where resource selection and/or scheduling is performed by the UE 405 (e.g., rather than a network node 110). In some aspects, the UE 405 may perform resource selection and/or scheduling by sensing channel availability for transmissions. For example, the UE 405 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 405 may perform resource selection and/or scheduling using SCI 430 received in the PSCCH 415, which may indicate occupied resources and/or channel parameters. Additionally. or alternatively, the UE 405 may perform resource selection and/or scheduling by determining a channel busy ratio (CBR) associated with various sidelink channels, which may be used for rate control (e.g., by indicating a maximum number of resource blocks that the UE 405 can use for a set of subframes).

In the transmission mode where resource selection and/or scheduling is performed by a UE 405, the UE 405 may generate sidelink grants, and may transmit the grants in SCI 430. A sidelink grant may indicate, for example, one or more parameters (e.g., transmission parameters) to be used for an upcoming sidelink transmission, such as one or more resource blocks to be used for the upcoming sidelink transmission on the PSSCH 420 (e.g., for TBs 435), one or more subframes to be used for the upcoming sidelink transmission, and/or a modulation and coding scheme (MCS) to be used for the upcoming sidelink transmission. In some aspects, a UE 405 may generate a sidelink grant that indicates one or more parameters for semi-persistent scheduling (SPS), such as a periodicity of a sidelink transmission. Additionally, or alternatively, the UE 405 may generate a sidelink grant for event-driven scheduling, such as for an on-demand sidelink message.

As indicated above. FIG. 4 is provided as an example. Other examples may differ from what is described with respect to FIG. 4.

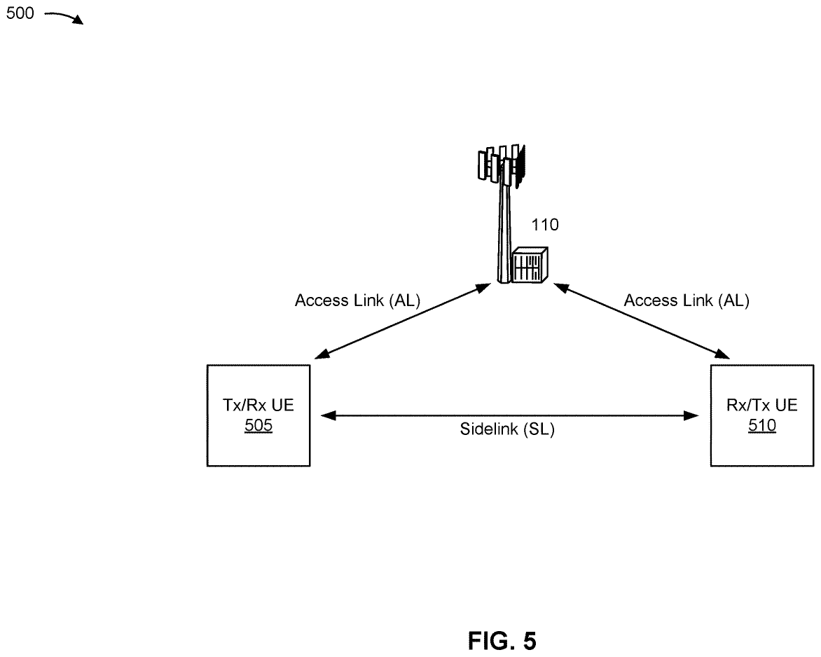

FIG. 5 is a diagram illustrating an example 500 of sidelink communications and access link communications, in accordance with the present disclosure.

As shown in FIG. 5, a transmitter (Tx)/receiver (Rx) UE 505 and an Rx/Tx UE 510 may communicate with one another via a sidelink, as described above in connection with FIG. 4. As further shown, in some sidelink modes, a network node 110 may communicate with the Tx/Rx UE 505 (e.g., directly or via one or more network nodes), such as via a first access link. Additionally. or alternatively, in some sidelink modes, the network node 110 may communicate with the Rx/Tx UE 510 (e.g., directly or via one or more network nodes), such as via a first access link. The Tx/Rx UE 505 and/or the Rx/Tx UE 510 may correspond to one or more UEs described elsewhere herein, such as the UE 120 of FIG. 1. Thus, a direct link between UEs 120 (e.g., via a PC5 interface) may be referred to as a sidelink, and a direct link between a network 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

As indicated above. FIG. 5 is provided as an example. Other examples may differ from what is described with respect to FIG. 5.

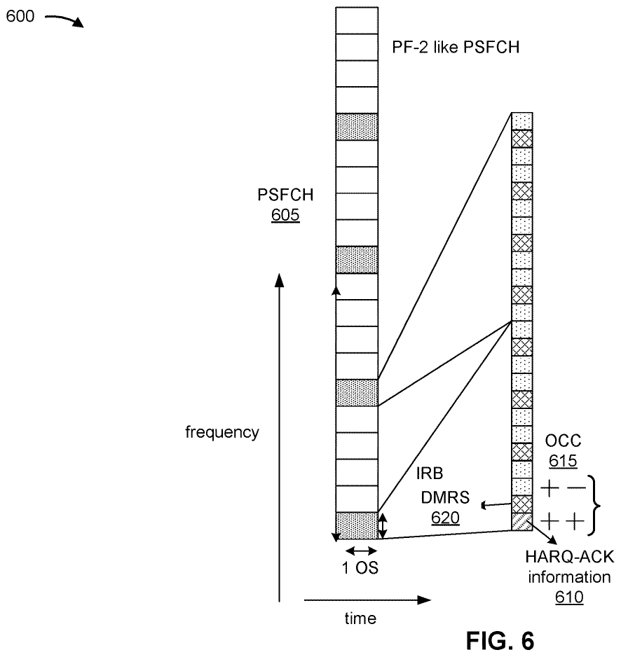

FIG. 6 is a diagram illustrating an example 60) of a physical sidelink feedback channel, in accordance with the present disclosure.

In some cases, a PSFCH such as the PSFCH 605 may be a PSFCH format 2 (PF2) resource. An OFDM waveform associated with a PF2 resource may use all of the resource blocks within the interlace. The PF2 resource may support type 1, type 2, and/or type 3 HARQ codebooks, which may include HARQ-ACK transmissions such as the HARQ-ACK information 610, with two or more bits for an ACK/NACK payload. To improve user multiplexing, a frequency domain orthogonal cover code (OCC), such as the OCC 615, which may be an OCC-2 or OCC-4, may be applied to PF2 data symbols and a DMRS 620. In some cases, a pseudo-random frequency division OCC (FD-OCC) may be applied across different interleaved resource blocks to reduce a peak-to-average power ratio (PAPR). If a receiver supports multiple PF2 resource transmissions, the receiver may be able to transmit up to two or four PSFCH transmissions per interlace (e.g., depending on UE capability). This may increase UE or PSFCH multiplexing capabilities by two or four times, respectively.

As indicated above. FIG. 6 is provided as an example. Other examples may differ from what is described with respect to FIG. 6.

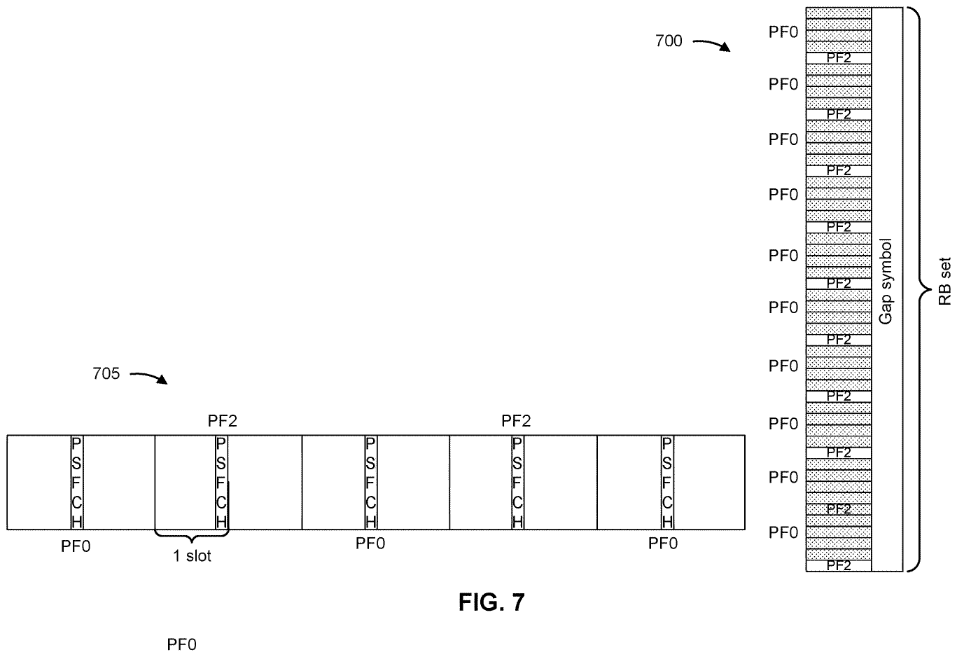

FIG. 7 is a diagram illustrating examples 700 and 705 of single-bit and multiple-bit physical sidelink feedback channel multiplexing, in accordance with the present disclosure.

In some cases, a PSFCH format 0 (PF0) interlace may carry a I-bit ACK-NACK and a PF2 interlace may carry multiple ACK-NACK bits for a HARQ codebook. In some cases, different PSFCH formats may be multiplexed using frequency division multiplexing (FDM) on different interlaces or may be multiplexed using time division multiplexing (TDM) on different PSFCH instances with universal hard partitioning configurations. PF0 and PF2 may not be able to be multiplexed in the same interlace and the same PSFCH symbol. PF0 and PF2 resources may need to be orthogonal in time and/or frequency. Universal hard partitioning may be used to ensure that distributed sidelink nodes do not transmit a PF0 transmission on the PF2 interlace within the same PSFCH instance. In some cases, each link may configure PF0 and PF2 resource pools within respective partitioning. In some cases, two options for global partitioning may be possible. As shown in the example 700. PF0 and PF2 may alternate according to a pattern within a resource block set. For example, the pattern may include repetitions of four PF0 instances and one PF2 instance. Alternatively, as shown in the example 705. PF0 and PF2 may alternate in each slot. For example, a first slot may use PF0, a second slot may use PF2, a third slot may use PF0, a fourth slot may use PF2, and a fifth slot may use PF0, among other examples.

As indicated above. FIG. 7 is provided as an example. Other examples may differ from what is described with respect to FIG. 7.

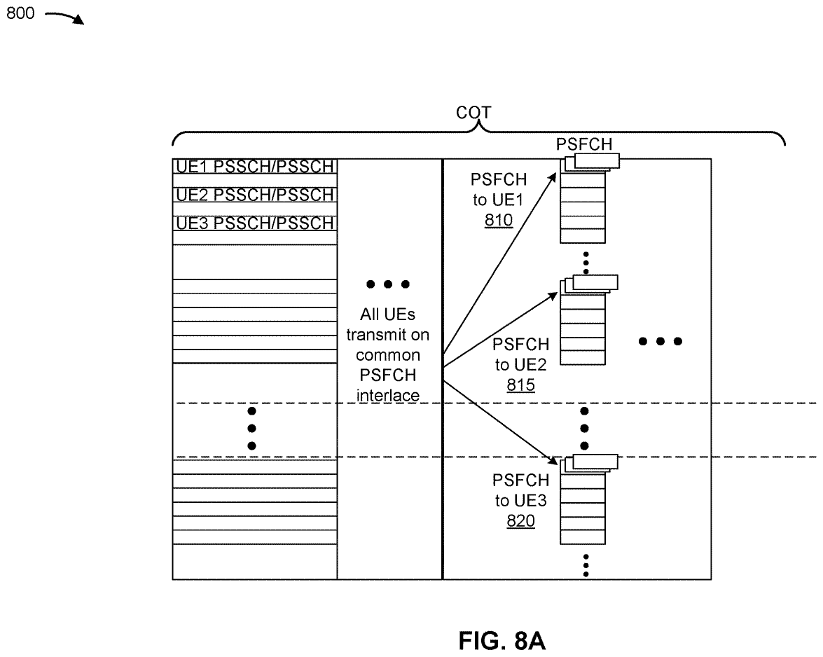

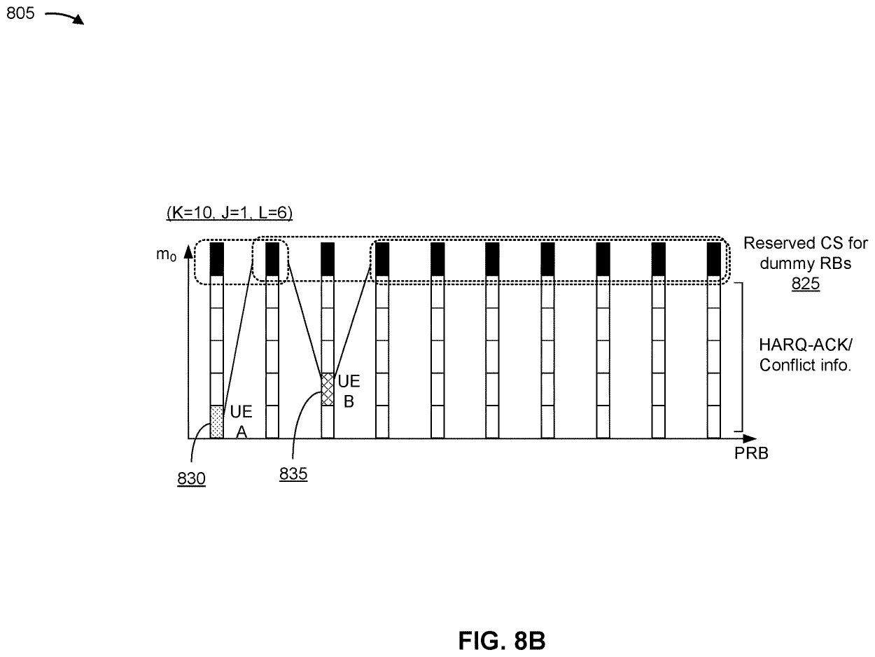

FIGS. 8A-8B are diagrams illustrating examples 800 and 805 of physical sidelink feedback channel and interlace transmissions, in accordance with the present disclosure.

In some cases, an interlaced PSFCH waveform may be used to satisfy occupied channel bandwidth (OCB) and power spectral density (PSD) limits for sidelink communications. For example, to meet the OCB and PSD requirement for PSFCH transmissions, a resource-block-based interlace may be supported for 15 kHz sub-carrier spacing (SCS) and/or 30 kHz SCS. However, an interleaved resource block based interlace waveform may not be acceptable for UE multiplexing. For example, an interleaved resource block based interlace may occupy ten resource blocks. With five total interlaces in 30 kHz SCS and six cyclic shift (CS) pairs, one PSFCH symbol may only be used to multiplex for 30 UEs with a 50-resource-block bandwidth. The UE multiplexing capacity may be ten times less than the legacy (e.g., non-interleaved) PSFCH for a given bandwidth as the interleaved resource block based interlace waveform uses ten resource blocks (compared to a single resource block in legacy PSFCH). In some cases, a PSFCH instance may be shared by all of the PSSCH receivers. One PSFCH symbol may not have 30+ resources for 30+ receivers, respectively, to transmit an ACK/NACK. This may not be acceptable for groupcast when a transmitter transmits to many receivers and needs to receive an ACK/NACK from each of the receivers.

In some cases, each PSFCH transmission may occupy a common interlace and zero or one or more dedicated physical resource blocks (PRBs). As shown in FIG. 8A, a PSFCH transmission to UE1 810, a PSFCH transmission to UE2 815, and a PSFCH transmission to UE3 820 may each occupy a common interlace and one or more PRBs. In some other cases, each PSFCH transmission may occupy an interlace (which may or may not be a dedicated interlace), and may or may not further apply code domain enhancement (such as OCC or PRB-level cyclic shifts). In some other cases, each PSFCH transmission may occupy some dedicated PRBs and some common PRBs. For example, a plurality of cyclic shift resources 825 may be reserved for dummy resource blocks, a first UE (such as UE1) may perform a PSFCH transmission using resource 830, and a second UE (such as UE2) may perform another PSFCH transmission using resource 835.

In some cases, one PF2 PSFCH resource may occupy an entire interlace, and multi-UE multiplexing capacity may be limited. For example, for 30 kHz SCS in a 20 MHz bandwidth, one PSFCH instance may only support up to 20 UEs (e.g., 4 FD-OCC×5 interlaces). The PSFCH instances that carry the PF2 transmissions may be configured periodically. For groupcast (e.g., groupcast option 2), the interleaved PF2 resources may not have enough capacity for all of the groupcast receivers to report ACK/NACK transmissions. This may result in reduced UE multiplexing capabilities.

Techniques and apparatuses are described herein for physical sidelink feedback channel multiplexing. In some aspects, a UE may receive configuration information that indicates a number of interleaved resource blocks to be used by a plurality of PSFCH resources that includes at least a first PSFCH resource and a second PSFCH resource. The first PSFCH resource and the second PSFCH resource may occupy interleaved resource blocks that are associated with an interlace index. The first PSFCH resource and the second PSFCH resource may be contiguous or may repeat in accordance with an interval. At least one of the first PSFCH resource and the second PSFCH resource may be a PF2 resource. For example, the first PSFCH resource may be a PF2 resource and the second PSFCH resource may be a PF0 resource. The UE may transmit a PSFCH communication, such as an ACK/NACK, via at least one of the first PSFCH resource or the second PSFCH resource. Instead of occupying all of the interleaved resource blocks within an interlace, one PSFCH resource may occupy a partial interlace (e.g., two or more interleaved resource blocks within the interlace) so that other PSFCH resources (e.g., PF2 resources) may also FDM in different partial interlaces (e.g., other interleaved resource blocks within the interlace) associated with the same interlace index. This may enable a larger number of UEs to perform PSFCH transmissions within an interlace, and therefore, may result in increased UE multiplexing capabilities. Additional details are described herein.

As indicated above, FIGS. 8A-8B are provided as examples. Other examples may differ from what is described with respect to FIGS. 8A-8B.

FIG. 9 is a diagram illustrating an example 900 of physical sidelink feedback channel multiplexing, in accordance with the present disclosure. A UE 905 may communicate with at least one of the network node 110 and a UE 910. The UE 905 and the UE 910 may include some or all of the features of the UE 120 described herein. In some aspects, the network node 110 may be or may include a base station, such as a disaggregated base station, or may be another UE.

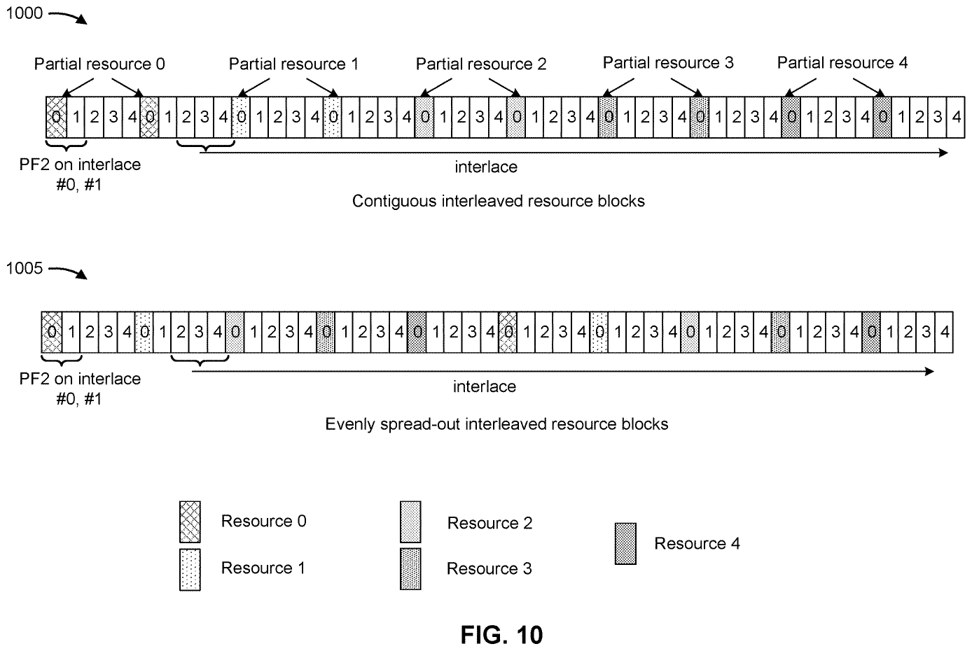

As shown by reference number 915, the network node 110 may identify a number of interleaved resource blocks to be used by a plurality of PSFCH resources. The plurality of PSFCH resources may include at least a first PSFCH resource and a second PSFCH resource. In some aspects, at least one of the first PSFCH resource and the second PSFCH resource may be a PF2 resource. For example, the first PSFCH resource may be a PF2 resource and the second PSFCH resource may be a PF0 resource. In some aspects, the plurality of PSFCH resources, such as the first PSFCH resource and the second PSFCH resource, may occupy interleaved resource blocks within a same interlace index that are contiguous or that are configured (e.g., repeat) in accordance with an interval. Additional details regarding these features are described in connection with FIG. 10.

In some aspects, an interlace may include a number of resource blocks. In one example, an interlace may include ten resource blocks, such as RB0, RB1, RB2, RB3, RB4, RB5, RB6, RB7, RB8, and RB9. A partial interlace may refer to a subset of the resource blocks within the interlace. In some aspects, an interlace may include at least a first partial interlace that includes a first number of interleaved resource blocks and a second partial interlace that includes a second number of interleaved resource blocks. For example, the first partial interlace may include RB0, RB2, RB4, RB6, and RB8, and the second partial interlace may include RB1, RB3, RB5, RB7, and RB9.

As shown by reference number 920, the network node 110 may transmit configuration information that indicates the number of interleaved resource blocks to be used by one or more of the plurality of PSFCH resources. The UE 905 may receive the configuration information from the network node 110 and/or from one or more other intermediate nodes between the UE 905 and the network node 110.

In some aspects, different PSFCH resources may occupy different FD-OCC resources (e.g., up to four resources). In some aspects, different PSFCH resources may occupy different interlaces (e.g., up to five interlaces or ten interlaces). In some aspects, different PSFCH resources may occupy different contiguous interleaved resource blocks within the same interlace index (e.g.,

$$\frac{10}{N}$$

partial interlace resources within an interlace). In this case, the multiplexing capacity of the partial interlaced PF2 resource may be

$$\frac{10}{N}$$

times greater than an interlaced based PF2 resource. In some aspects, for example, to reduce PAPR, different interleaved resource blocks of the PF2 interlace may use different OCC indices.

In some aspects, for interleaved PF2 resource mapping, RRC information and/or SCI information may indicate a set of PSFCH resources per link. The RRC information and/or the SCI information may indicate to use a transmitter identifier (Tx ID)-based hashing function or a group identifier (group ID)-based hashing function to select a PSFCH resource within the set of PSFCH resources. In some aspects, the transmitter UE (e.g., the UE 910) may use RRC information and/or SCI to indicate a set of PSFCH resources for a receiver UE to select from. For example, the transmitter UE may select the PSFCH interlace index, and the receiver UE (e.g., the UE 905) may select the OCC index and the partial interlace based at least in part on the hashing function. In some aspects, the hashing function may help to reduce PSFCH resource collision among different links. In some aspects, the hashing function may be:

$$( {P}_{ID} + {M}_{ID} ) mod {N}_{OCC / P \_ int - set}^{PSFCH} ,$$

where

$${N}_{OCC / P \_ int - set}^{PSFCH}$$

is the number of OCC resources or partial interlace resources in the indicated set of PSFCH resources. P_{ID} is the Tx ID, and M_{ID} is the groupcast ID (if groupcast is supported).

In some aspects, the plurality of PSFCH resources may include at least the first PSFCH resource and the second PSFCH resource, where the first PSFCH resource is a PF2 resource and the second PSFCH resource is a PF0 resource. In some aspects, if PF0 and PF2 are multiplexed (using FDM) in different interlaces, the transmitter UE may transmit both a partial interlaced PF2 and a partial interlaced PF0 based bandwidth padding signal. The bandwidth padding signal may be transmitted on a common interlace and/or using a reserved cyclic shift resource. This may, for example, fulfill an OCB constraint. In some aspects, the bandwidth padding signal may be based at least in part on the PF0, and may be transmitted on a reserved cyclic shift resource within the common interlace. The common interlace may be an interlace that is reserved within the PF0 interlaces for transmitting the bandwidth padding signal. The PF0 bandwidth padding signal may use the reserved cyclic shift resource so that other ACK/NACK carrying PF0 resources can still multiplex with different cyclic shift resources in the same common interlace. In some aspects, if an interleaved resource block of the common interlace is within a threshold number of resource blocks (e.g., less than or equal to X RBs) from the partial interlaced PF2 interleaved resource blocks, the interleaved resource blocks of the common interlace may be dropped and the transmit power (e.g., under a PSD limit) may be used for the PF2 resource.

In some aspects, the PF0-based bandwidth padding signal in the common interlace may be on a different interlace than the PF2 interlace, and the transmitter UE may require additional PAPR backoff. In some aspects, one FD-OCC resource (e.g., resource index) may be assigned as a reserved OCC resource, and the transmitter UE may transmit an ACK/NACK carrying a PF2 interlace and may duplicate a PF2 DMRS (or DMRS plus data resource elements) on the remaining interleaved resource blocks of the same interlace or a designated common interlace. In some aspects, the PF2-based bandwidth padding signal may help the partial interlaced PF2 resource signal to fulfill an OCB constraint. In some aspects, a PF2-based bandwidth padding signal waveform may be a repetition of a partial interlace PF2 DMRS on the remaining interleaved resource blocks in the resource block set with reserved OCC index. In some other aspects, the PF2-based bandwidth padding signal may be a repetition of the partial interlace PF2 DMRS and data resource elements on the remaining interleaved resource blocks in the resource block set with reserved OCC index. In some aspects, the reserved FD-OCC index may shift across the interleaved resource blocks. This may reduce the PAPR.

In some aspects, a PF2-based bandwidth padding signal may occupy a designated common interlace within the PF2 interlaces. In this example, only one FD-OCC resource in the designated common interlace may be reserved. Other non-reserved FD-OCC resources in the common interlace may still be used by other UEs. In some other aspects, the PF2 based bandwidth padding signal may occupy the same interlace as an ACK/NACK carrying the partial interlace. In this example, a regular interlace waveform may result in reduced PAPR. However, one of the FD-OCC resources may be reserved in every PF2 interlace, which may result in increased overhead. In some aspects, an indication of whether to transmit the bandwidth padding signal may be configurable by RRC. For example, the configuration information may indicate whether or not to transmit the bandwidth padding signal. The indication of whether to transmit the bandwidth padding signal may be based at least in part on a region, a regulation, or a band, among other examples.

As shown by reference number 925, the UE 910 may transmit a sidelink communication. The sidelink communication may be transmitted to the UE 905 and/or to one or more other UEs. For example, the sidelink communication may include a unicast transmission, a multicast transmission, a groupcast transmission, or a broadcast transmission, among other examples. The sidelink communication may indicate for the receiver UEs to transmit an ACK/NACK based at least in part on receiving the sidelink communication.

As shown by reference 930, the UE 905 may transmit a PSFCH communication via one or more of the plurality of PSFCH resources. The PSFCH communication may be, for example, an ACK/NACK that is based at least in part on the sidelink communication. In some aspects, the UE 905 may be configured to select one or more of the PSFCH resources for performing the ACK/NACK transmission. For example, the UE 910 and/or the network node 110 may indicate a PSFCH interlace index, and the UE 905 may select an OCC index and a partial interlace for transmitting an ACK/NACK. The UE 905 may select the OCC index and the partial interlace for transmitting the ACK/NACK based at least in part on a hashing function.

As described herein, a PF2 PSFCH resource may occupy an entire interlace, and multi-UE multiplexing capacity may be limited. For example, for 30 kHz SCS in a 20 MHz bandwidth, one PSFCH instance may only support up to 20 UEs. The PSFCH instances that carry the PF2 transmissions may be configured periodically. In one example, the interleaved PF2 resources may not have enough capacity for each of a plurality of groupcast receivers to report ACK/NACK transmissions. This may result in reduced UE multiplexing capabilities. Using the techniques and apparatuses described herein, instead of occupying all of the interleaved resource blocks within an interlace, one PSFCH resource may occupy a partial interlace so that other PSFCH resources may also FDM in different partial interfaces within the same interlace. This may enable a larger number of UEs to transmit PSFCH communications within an interlace, and therefore, may result in increased UE multiplexing capabilities.

As indicated above, FIG. 9 is provided as an example. Other examples may differ from what is described with respect to FIG. 9.

FIG. 10 is a diagram illustrating examples 1000 and 1005 of partial interlace configurations for physical sidelink feedback channel communications, in accordance with the present disclosure. As described herein, a plurality of PSFCH resources may occupy interleave resource blocks within a same interlace index that are contiguous or that repeat in accordance with an interval. In one example, as shown in the example 1005, a plurality of PSFCH resources, such as resource 0, resource 1, resource 2, resource 3, and resource 4, may occupy contiguous interleaved resource blocks. For example, resource 0 may occupy a first RB0 and a second RB, resource 1 may occupy a third RB0 and a fourth RB0, resource 2 may occupy a fifth RB0 and a sixth RB0, resource 3 may occupy a seventh RB0 and an eight RB0, and resource 4 may occupy a ninth RB0 and a tenth RB0 within an interlace. In another example, as shown in the example 1010, a plurality of PSFCH resources may occupy interleaved resource blocks that are spaced in accordance with an interval and/or that are spread out evenly. For example, resource 0 may occupy a first RB0 and a sixth RB0, resource 1 may occupy a second RB0 and a seventh RB0, resource 2 may occupy a third RB0 and an eighth RB0, resource 3 may occupy a fourth RB0 and a ninth RB0, and resource 4 may occupy a fifth RB0 and a tenth RB0 within an interlace.

As indicated above, FIG. 10 is provided as an example. Other examples may differ from what is described with respect to FIG. 10.

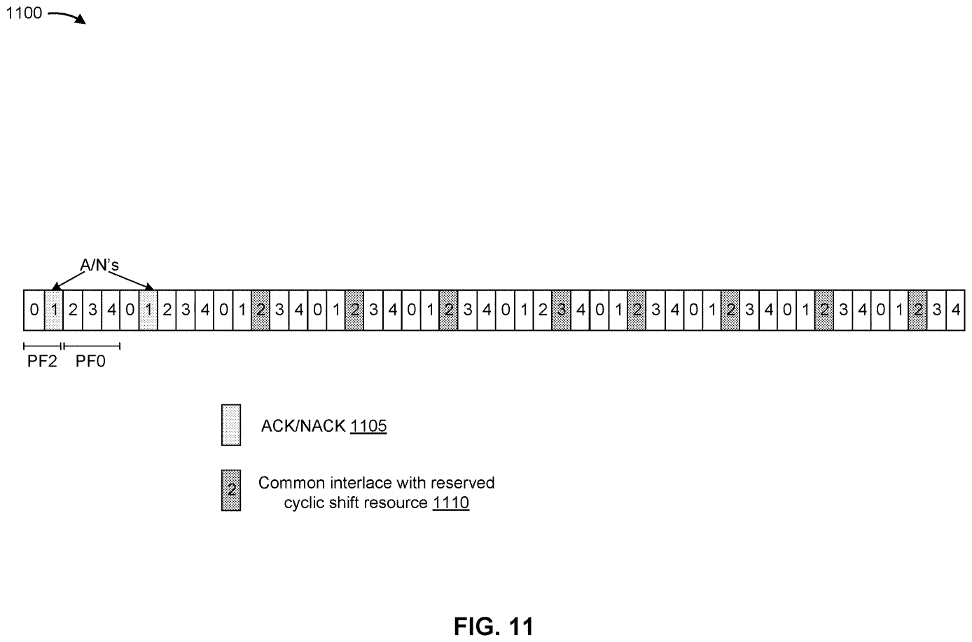

FIG. 11 is a diagram illustrating an example 1100 of partial interlaced physical sidelink feedback channel frequency division multiplexing, in accordance with the present disclosure. A plurality of PSFCH resources may include at least a first PSFCH resource and a second PSFCH resource, where the first PSFCH resource is a PF2 resource and the second PSFCH resource is a PF0 resource. An ACK/NACK 1105 may be transmitted via at least the PF2 resource. In some aspects, if PF0 and PF2 are multiplexed (using FDM) in different interlaces, the transmitter UE may transmit both a partial interlaced PF2 and a partial interlaced PF0 based bandwidth padding signal. The bandwidth padding signal may be transmitted on a common interlace and/or using a reserved cyclic shift resource, such as the reserved cyclic shift resource 1110. In some aspects, the bandwidth padding signal may be based at least in part on the PF0 resource, and may be transmitted on a reserved cyclic shift resource 1110 within the common interlace. The common interlace may be an interlace that is reserved within the PF0 interlaces for transmitting the bandwidth padding signal. The PF0 bandwidth padding signal may use the reserved cyclic shift resource 1110 so that the ACK/NACK 1105 carrying PF0 resources can still multiplex with the cyclic shift resources in the same common interlace. In some aspects, if an interleaved resource blocks of the common interlace is within a threshold number of resource blocks (e.g., less than or equal to X RBs) from the partial interlaced PF2 interleaved resource blocks, the interleaved resource blocks of the common interlace may be dropped and the transmit power (e.g., under a PSD limit) may be used for the PF2 resource.

As indicated above. FIG. 11 is provided as an example. Other examples may differ from what is described with respect to FIG. 11.

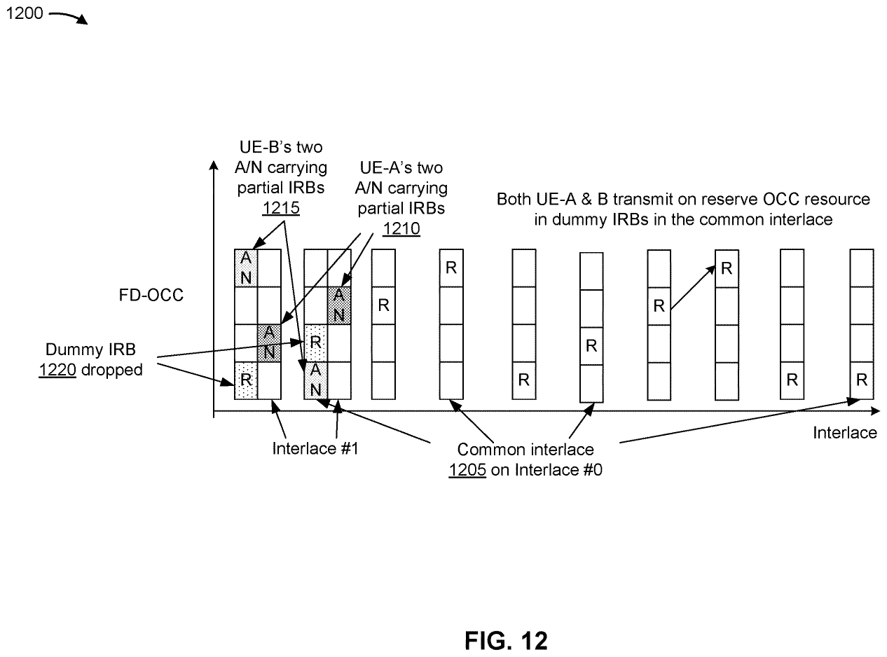

FIG. 12 is a diagram illustrating an example 1200 of partial interlace transmission and dropping, in accordance with the present disclosure. In some aspects, the common interlace 1205 may be an interlace that is reserved within the PF0 interlaces for transmitting a bandwidth padding signal. A first UE (e.g., UE-A) may transmit two ACK/NACKs carrying partial interlaced resource blocks 1210 within a first interlace. A second UE (e.g., UE-B) may transmit two ACK/NACKs carrying partial interlaced resource blocks 1215 within another interlace such as the common interlace 1205. Both UE-A and UE-B may transmit ACK/NACKs and/or bandwidth padding signals on reserved OCC resources in dummy interlaced resource blocks in the common interlace. In some aspects, one or more dummy interleaved resource blocks 1220 may be dropped. For example, one or more dummy interleaved resource blocks 1220 of the common interlace may be dropped based at least in part on the dummy resource block(s) being within a threshold number of resource blocks (e.g., less than or equal to X RBs) from the partial interlaced PF2 resource blocks. In this case, the transmit power (e.g., under a PSD limit) may be used for the PF2 resource.

As indicated above, FIG. 12 is provided as an example. Other examples may differ from what is described with respect to FIG. 12.

FIG. 13 is a diagram illustrating an example process 1300 performed, for example, by a UE, in accordance with the present disclosure. Example process 1300 is an example where the UE (e.g., UE 120) performs operations associated with PSFCH multiplexing.

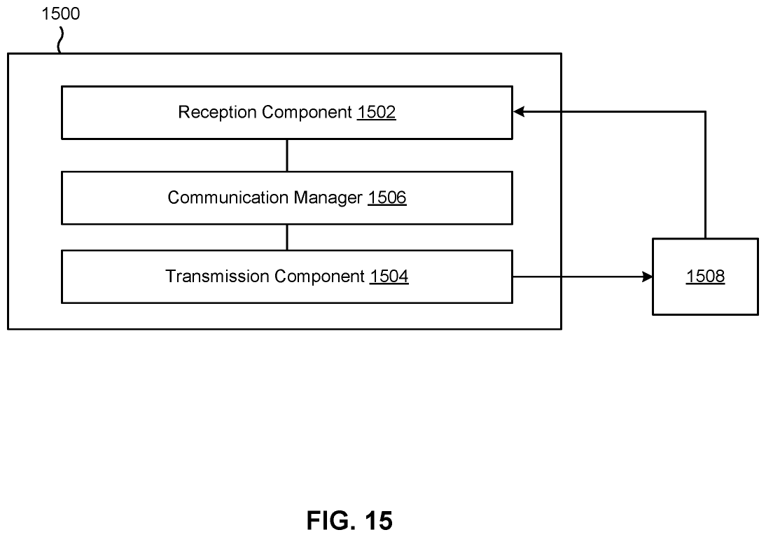

As shown in FIG. 13, in some aspects, process 13001 may include receiving configuration information that indicates a number of interleaved resource blocks to be used by a plurality of physical sidelink feedback channel (PSFCH) resources, the plurality of PSFCH resources including at least a first PSFCH resource that occupies a first number of interleaved resource blocks within an interlace and a second PSFCH resource that occupies a second number of interleaved resource blocks within the interlace, the first number of interleaved resource blocks and the second number of interleaved resource blocks being contiguous or configured in accordance with an interval (block 1310). For example, the UE (e.g., using reception component 1502 and/or communication manager 1506, depicted in FIG. 15) may receive configuration information that indicates a number of interleaved resource blocks to be used by a plurality of physical sidelink feedback channel (PSFCH) resources, the plurality of PSFCH resources including at least a first PSFCH resource that occupies a first number of interleaved resource blocks within an interlace and a second PSFCH resource that occupies a second number of interleaved resource blocks within the interlace, the first number of interleaved resource blocks and the second number of interleaved resource blocks being contiguous or configured in accordance with an interval, as described above.

As further shown in FIG. 13, in some aspects, process 1300 may include transmitting a PSFCH communication via at least one of the first PSFCH resource or the second PSFCH resource (block 1320). For example, the UE (e.g., using transmission component 1504 and/or communication manager 1506, depicted in FIG. 15) may transmit a PSFCH communication via at least one of the first PSFCH resource or the second PSFCH resource, as described above.

Process 1300 may include additional aspects, such as any single aspect or am combination of aspects described below and/or in connection with one or more other processes described elsewhere herein.

In a first aspect, the first PSFCH resource is configured to be used by the UE and the second PSFCH resource is configured to be used by another UE.

In a second aspect, alone or in combination with the first aspect, at least one of the first PSFCH resource and the second PSFCH resource is a PSFCH format 2 resource.

In a third aspect, alone or in combination with one or more of the first and second aspects, the first PSFCH resource and the second PSFCH resource occupy different frequency domain orthogonal cover codes.

In a fourth aspect, alone or in combination with one or more of the first through third aspects, a portion of the first PSFCH resource and a portion of the second PSFCH resource occupy different interlaces.

In a fifth aspect, alone or in combination with one or more of the first through fourth aspects, the first PSFCH resource and the second PSFCH resource occupy different contiguous interleaved resource blocks within the interlace.

In a sixth aspect, alone or in combination with one or more of the first through fifth aspects, process 1300 includes receiving radio resource control (RRC) information or sidelink control information (SCI) that indicates the plurality of PSFCH resources and that indicates to use a hashing function to select a PSFCH resource of the plurality of PSFCH resources.

In a seventh aspect, alone or in combination with one or more of the first through sixth aspects, the hashing function is based at least in part on a number of orthogonal cover codes or a number of resources in the plurality of PSFCH resources, and at least one of a transmitter identifier or a groupcast identifier.

In an eighth aspect, alone or in combination with one or more of the first through seventh aspects, the first PSFCH resource is a PSFCH format 2 (PF2) resource and the second PSFCH resource is a PSFCH format 0 (PF0) resource, and wherein the PF2 resource and the PF0 resource are multiplexed in different interlaces using frequency division multiplexing.

In a ninth aspect, alone or in combination with one or more of the first through eighth aspects, process 1300 includes transmitting a bandwidth padding signal associated with the PF2 resource and the PF0 resource using a common interlace.

In a tenth aspect, alone or in combination with one or more of the first through ninth aspects, the bandwidth padding signal is based at least in part on the PF0 resource and is transmitted using a reserved cyclic shift resource in the common interlace.

In an eleventh aspect, alone or in combination with one or more of the first through tenth aspects, the common interlace is a single reserved interlace in the PF0 resource that is reserved for the bandwidth padding signal.

In a twelfth aspect, alone or in combination with one or more of the first through eleventh aspects, the bandwidth padding signal is transmitted via the reserved cyclic shift resource, and wherein an acknowledgement signal carrying a PF0 resource transmission is multiplexed with other cyclic shift resources in the common interlace.

In a thirteenth aspect, alone or in combination with one or more of the first through twelfth aspects, process 1300 includes dropping an interleaved resource block associated with the common interlace based at least in part on the interleaved resource block associated with the common interlace being located within a number of resource blocks from one or more interleaved resource blocks associated with the PF2 resource.

In a fourteenth aspect, alone or in combination with one or more of the first through thirteenth aspects, the configuration information indicates to assign one frequency division (FD) orthogonal cover code (OCC) resource as a reserved OCC resource, and wherein the UE is configured to transmit an acknowledgement message carrying a PF2 resource interlace and to duplicate a PF2 resource demodulation reference signal (DMRS) on one or more remaining interleaved resource blocks within a same interlace or a common interlace.

In a fifteenth aspect, alone or in combination with one or more of the first through fourteenth aspects, duplicating the PF2 resource DMRS comprises duplicating the PF2 resource DMRS and one or more data resource elements on the one or more remaining interleaved resource blocks within the same interlace or the common interlace.

In a sixteenth aspect, alone or in combination with one or more of the first through fifteenth aspects, process 1300 includes transmitting a PF2 resource based bandwidth padding signal.

In a seventeenth aspect, alone or in combination with one or more of the first through sixteenth aspects, a waveform associated with the PF2 resource based bandwidth padding signal is based at least in part on a repetition of a PF2 resource DMRS on one or more remaining interleaved resource blocks in a resource block set having a reserved OCC index.

In an eighteenth aspect, alone or in combination with one or more of the first through seventeenth aspects, a waveform associated with the PF2 resource based bandwidth padding signal is based at least in part on a repetition of a PF2 resource DMRS and one or more data resource elements on one or more remaining interleaved resource blocks in a resource block set having a reserved OCC index.

In a nineteenth aspect, alone or in combination with one or more of the first through eighteenth aspects, the PF2 resource based bandwidth padding signal occupies a dedicated common interlace of one or more interlaces associated with the PF2 resource.

In a twentieth aspect, alone or in combination with one or more of the first through nineteenth aspects, the PF2 resource based bandwidth padding signal occupies a same interlace as an acknowledgement message that uses an interface associated with the PF2 resource.

In a twenty-first aspect, alone or in combination with one or more of the first through twentieth aspects, radio resource control (RRC) information indicates whether to transmit the PF2 resource based bandwidth padding signal.

In a twenty-second aspect, alone or in combination with one or more of the first through twenty-first aspects, the RRC information that indicates whether to transmit the PF2 resource based bandwidth padding signal indicates whether to transmit the PF2 resource based bandwidth padding signal based at least in part on a region, a regulation, or a band.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a network node, in accordance with the present disclosure. Example process 1400 is an example where the network node (e.g., network node 110) performs operations associated with PSFCH multiplexing.

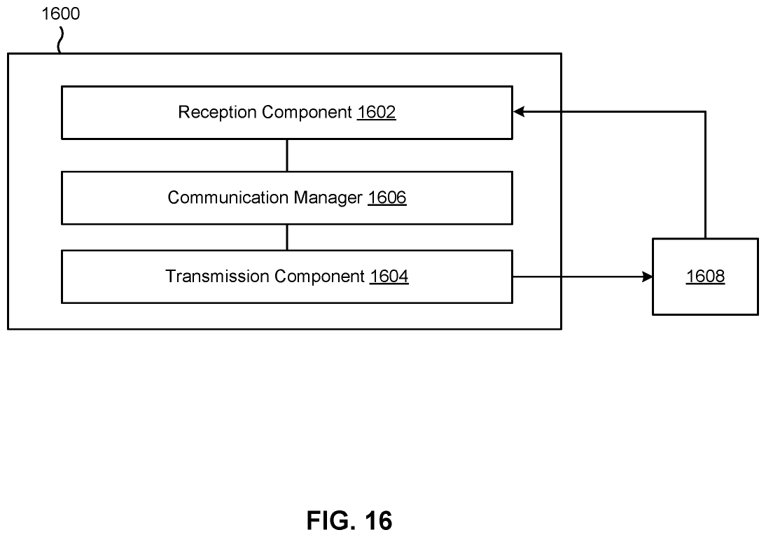

As shown in FIG. 14, in some aspects, process 1400 may include identifying a number of interleaved resource blocks to be used by a plurality of physical sidelink feedback channel (PSFCH) resources, the plurality of PSFCH resources including at least a first PSFCH resource that occupies a first number of interleaved resource blocks within an interlace and a second PSFCH resource that occupies a second number of interleaved resource blocks within the interlace, the first number of interleaved resource blocks and the second number of interleaved resource blocks being contiguous or configured in accordance with an interval (block 1410). For example, the network node (e.g., using communication manager 1606, depicted in FIG. 16) may identify a number of interleaved resource blocks to be used by a plurality of physical sidelink feedback channel (PSFCH) resources, the plurality of PSFCH resources including at least a first PSFCH resource that occupies a first number of interleaved resource blocks within an interlace and a second PSFCH resource that occupies a second number of interleaved resource blocks within the interlace, the first number of interleaved resource blocks and the second number of interleaved resource blocks being contiguous or configured in accordance with an interval, as described above.

As further shown in FIG. 14, in some aspects, process 1400 may include transmitting configuration information that indicates the number of interleaved resource blocks to be used by the plurality of PSFCH resources (block 1420). For example, the network node (e.g., using transmission component 1604 and/or communication manager 1606, depicted in FIG. 16) may transmit configuration information that indicates the number of interleaved resource blocks to be used by the plurality of PSFCH resources, as described above.

Process 1400 may include additional aspects, such as any single aspect or any combination of aspects described below and/or in connection with one or more other processes described elsewhere herein.

In a first aspect, the first PSFCH resource is configured to be used by a first UE and the second PSFCH resource is configured to be used by a second UE.

In a second aspect, alone or in combination with the first aspect, transmitting the configuration information comprises transmitting radio resource control information that includes the configuration information.

In a third aspect, alone or in combination with one or more of the first and second aspects, transmitting the configuration information comprises transmitting sidelink control information that includes the configuration information.

In a fourth aspect, alone or in combination with one or more of the first through third aspects, at least one of the first PSFCH resource and the second PSFCH resource is a PSFCH format 2 resource.

In a fifth aspect, alone or in combination with one or more of the first through fourth aspects, the first PSFCH resource and the second PSFCH resource occupy different frequency domain orthogonal cover codes.

In a sixth aspect, alone or in combination with one or more of the first through fifth aspects, a portion of the first PSFCH resource and a portion of the second PSFCH resource occupy different interlaces.

In a seventh aspect, alone or in combination with one or more of the first through sixth aspects, the first PSFCH resource and the second PSFCH resource occupy different contiguous interleaved resource blocks within the interlace.

In an eighth aspect, alone or in combination with one or more of the first through seventh aspects, the first PSFCH resource is a PSFCH format 2 (PF2) resource and the second PSFCH resource is a PSFCH format 0 (PF0) resource, and wherein the PF2 resource and the PF0 resource are multiplexed in different interlaces using frequency division multiplexing.

In a ninth aspect, alone or in combination with one or more of the first through eighth aspects, the configuration information indicates to transmit a bandwidth padding signal associated with the PF2 resource and the PF0 resource using a common interlace.

In a tenth aspect, alone or in combination with one or more of the first through ninth aspects, the configuration information indicates to transmit a bandwidth padding signal, that is based at least in part on the PF0 resource, using a reserved cyclic shift resource in the common interlace.

In an eleventh aspect, alone or in combination with one or more of the first through tenth aspects, the configuration information indicates to assign one frequency division (FD) orthogonal cover code (OCC) resource as a reserved OCC resource, to transmit an acknowledgement message carrying a PF2 resource interlace, and to duplicate a PF2 resource demodulation reference signal (DMRS) on one or more remaining interleaved resource blocks within a same interlace or a common interlace.

In a twelfth aspect, alone or in combination with one or more of the first through eleventh aspects, the configuration information further indicates to transmit a PF2 resource based bandwidth padding signal.

In a thirteenth aspect, alone or in combination with one or more of the first through twelfth aspects, the configuration information indicates that the PF2 resource based bandwidth padding signal is to occupy a dedicated common interlace of one or more interlaces associated with the PF2 resource.

In a fourteenth aspect, alone or in combination with one or more of the first through thirteenth aspects, the configuration information indicates that the PF2 resource based bandwidth padding signal is to occupy a same interlace as an acknowledgement message that uses an interlace associated with the PF2 resource.

In a fifteenth aspect, alone or in combination with one or more of the first through fourteenth aspects, the configuration information indicates whether to transmit the PF2 resource based bandwidth padding signal based at least in part on a region, a regulation, or a band.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication, in accordance with the present disclosure. The apparatus 1500 may be a UE, or a UE may include the apparatus 1500. In some aspects, the apparatus 1500 includes a reception component 1502, a transmission component 1504, and/or a communication manager 1506, which may be in communication with one another (for example, via one or more buses and/or one or more other components). In some aspects, the communication manager 1506 is the communication manager 140 described in connection with FIG. 1. As shown, the apparatus 1500 may communicate with another apparatus 1508, such as a UE or a network node (such as a CU, a DU, an RU, or a base station), using the reception component 1502 and the transmission component 1504.

In some aspects, the apparatus 1500 may be configured to perform one or more operations described herein in connection with FIGS. 9-12. Additionally, or alternatively, the apparatus 1500 may be configured to perform one or more processes described herein, such as process 1300 of FIG. 13. In some aspects, the apparatus 1500 and/or one or more components shown in FIG. 15 may include one or more components of the UE described in connection with FIG. 2. Additionally, or alternatively, one or more components shown in FIG. 15 may be implemented within one or more components described in connection with FIG. 2. Additionally. or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the UE described in connection with FIG. 2.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1508. In some aspects, the transmission component 1504 may include one or more antennas, a modem, a modulator, a transmit MIMO processor, a transmit processor, a controller/processor, a memory, or a combination thereof, of the UE described in connection with FIG. 2. In some aspects, the transmission component 1504 may be co-located with the reception component 1502 in a transceiver.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally. or alternatively, the communication manager 1506 may generate and/or provide control information to the reception component 1502 and/or the transmission component 1504 to control reception and/or transmission of communications.

The reception component 1502 may receive configuration information that indicates a number of interleaved resource blocks to be used by a plurality of physical sidelink feedback channel (PSFCH) resources, the plurality of PSFCH resources including at least a first PSFCH resource that occupies a first number of interleaved resource blocks within an interlace and a second PSFCH resource that occupies a second number of interleaved resource blocks within the interlace, the first number of interleaved resource blocks and the second number of interleaved resource blocks being contiguous or configured in accordance with an interval. The transmission component 1504 may transmit a PSFCH communication via at least one of the first PSFCH resource or the second PSFCH resource.

The reception component 1502 may receive radio resource control (RRC) information or sidelink control information (SCI) that indicates the plurality of PSFCH resources and that indicates to use a hashing function to select a PSFCH resource of the plurality of PSFCH resources.

The transmission component 1504 may transmit a bandwidth padding signal associated with the PF2 resource and the PF0 resource using a common interlace.

The communication manager 1506 may drop an interleaved resource block associated with the common interlace based at least in part on the interleaved resource block associated with the common interlace being located within a number of resource blocks from one or more interleaved resource blocks associated with the PF2 resource.

The transmission component 1504 may transmit a PF2 resource based bandwidth padding signal.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally. or alternatively, a set of (one or more) components shown in FIG. 15 may perform one or more functions described as being performed by another set of components shown in FIG. 15.

FIG. 16 is a diagram of an example apparatus 1600 for wireless communication, in accordance with the present disclosure. The apparatus 1600 may be a network node, or a network node may include the apparatus 1600. In some aspects, the apparatus 1600 includes a reception component 1602, a transmission component 1604, and/or a communication manager 1606, which may be in communication with one another (for example, via one or more buses and/or one or more other components). In some aspects, the communication manager 1606 is the communication manager 150 described in connection with FIG. 1. As shown, the apparatus 1600 may communicate with another apparatus 1608, such as a UE or a network node (such as a CU, a DU, an RU, or a base station), using the reception component 1602 and the transmission component 1604.

In some aspects, the apparatus 1600) may be configured to perform one or more operations described herein in connection with FIGS. 9-12. Additionally, or alternatively, the apparatus 1600 may be configured to perform one or more processes described herein, such as process 1400 of FIG. 14. In some aspects, the apparatus 1600 and/or one or more components shown in FIG. 16 may include one or more components of the network node described in connection with FIG. 2. Additionally, or alternatively, one or more components shown in FIG. 16 may be implemented within one or more components described in connection with FIG. 2. Additionally. or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1608. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the network node described in connection with FIG. 2. In some aspects, the reception component 1602 and/or the transmission component 1604 may include or may be included in a network interface. The network interface may be configured to obtain and/or output signals for the apparatus 1600 via one or more communications links, such as a backhaul link, a midhaul link, and/or a fronthaul link.

The transmission component 1604 may transmit communications, such as reference signals, control information, data communications, or a combination thereof, to the apparatus 1608. In some aspects, one or more other components of the apparatus 1600 may generate communications and may provide the generated communications to the transmission component 1604 for transmission to the apparatus 1608. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1608. In some aspects, the transmission component 1604 may include one or more antennas, a modem, a modulator, a transmit MIMO processor, a transmit processor, a controller/processor, a memory, or a combination thereof, of the network node described in connection with FIG. 2. In some aspects, the transmission component 1604 may be co-located with the reception component 1602 in a transceiver.

The communication manager 1606 may support operations of the reception component 1602 and/or the transmission component 1604. For example, the communication manager 1606 may receive information associated with configuring reception of communications by the reception component 1602 and/or transmission of communications by the transmission component 1604. Additionally, or alternatively, the communication manager 1606 may generate and/or provide control information to the reception component 1602 and/or the transmission component 1604 to control reception and/or transmission of communications.

The communication manager 1606 may identify a number of interleaved resource blocks to be used by a plurality of physical sidelink feedback channel (PSFCH) resources, the plurality of PSFCH resources including at least a first PSFCH resource that occupies a first number of interleaved resource blocks within an interlace and a second PSFCH resource that occupies a second number of interleaved resource blocks within the interlace, the first number of interleaved resource blocks and the second number of interleaved resource blocks being contiguous or configured in accordance with an interval. The transmission component 1604 may transmit configuration information that indicates the number of interleaved resource blocks to be used by the plurality of PSFCH resources.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally. or alternatively, a set of (one or more) components shown in FIG. 16 may perform one or more functions described as being performed by another set of components shown in FIG. 16.

The following provides an overview of some Aspects of the present disclosure:

Aspect 1: A method of wireless communication performed by a user equipment (UE), comprising: receiving configuration information that indicates a number of interleaved resource blocks to be used by a plurality of physical sidelink feedback channel (PSFCH) resources, the plurality of PSFCH resources including at least a first PSFCH resource that occupies a first number of interleaved resource blocks within an interlace and a second PSFCH resource that occupies a second number of interleaved resource blocks within the interface, the first number of interleaved resource blocks and the second number of interleaved resource blocks being contiguous or configured in accordance with an interval; and transmitting a PSFCH communication via at least one of the first PSFCH resource or the second PSFCH resource.

Aspect 2: The method of Aspect 1, wherein the first PSFCH resource is configured to be used by the UE and the second PSFCH resource is configured to be used by another UE.

Aspect 3: The method of any of Aspects 1-2, wherein at least one of the first PSFCH resource and the second PSFCH resource is a PSFCH format 2 resource.

Aspect 4: The method of any of Aspects 1-3, wherein the first PSFCH resource and the second PSFCH resource occupy different frequency domain orthogonal cover codes.

Aspect 5: The method of any of Aspects 14, wherein a portion of the first PSFCH resource and a portion of the second PSFCH resource occupy different interlaces.

Aspect 6: The method of any of Aspects 1-5, wherein the first PSFCH resource and the second PSFCH resource occupy different contiguous interleaved resource blocks within the interlace.

Aspect 7: The method of any of Aspects 1-0, further comprising receiving radio resource control (RRC) information or sidelink control information (SCI) that indicates the plurality of PSFCH resources and that indicates to use a hashing function to select a PSFCH resource of the plurality of PSFCH resources.

Aspect 8: The method of Aspect 7, wherein the hashing function is based at least in part on a number of orthogonal cover codes or a number of resources in the plurality of PSFCH resources, and at least one of a transmitter identifier or a groupcast identifier.

Aspect 9: The method of any of Aspects 1-8, wherein the first PSFCH resource is a PSFCH format 2 (PF2) resource and the second PSFCH resource is a PSFCH format 0 (PF0) resource, and wherein the PF2 resource and the PF0 resource are multiplexed in different interlaces using frequency division multiplexing.

Aspect 10: The method of Aspect 9, further comprising transmitting a bandwidth padding signal associated with the PF2 resource and the PF0 resource using a common interlace.

Aspect 11: The method of Aspect 10, wherein the bandwidth padding signal is based at least in part on the PF0 resource and is transmitted using a reserved cyclic shift resource in the common interlace.

Aspect 12: The method of Aspect 11, wherein the common interlace is a single reserved interlace in the PF0 resource that is reserved for the bandwidth padding signal.

Aspect 13: The method of Aspect 12, wherein the bandwidth padding signal is transmitted via the reserved cyclic shift resource, and wherein an acknowledgement signal carrying a PF0 resource transmission is multiplexed with other cyclic shift resources in the common interlace.

Aspect 14: The method of Aspect 12, further comprising dropping an interleaved resource block associated with the common interlace based at least in part on the interleaved resource block associated with the common interlace being located within a number of resource blocks from one or more interleaved resource blocks associated with the PF2 resource.

Aspect 15: The method of Aspect 9, wherein the configuration information indicates to assign one frequency division (FD) orthogonal cover code (OCC) resource as a reserved OCC resource, and wherein the UE is configured to transmit an acknowledgement message carrying a PF2 resource interlace and to duplicate a PF2 resource demodulation reference signal (DMRS) on one or more remaining interleaved resource blocks within a same interlace or a common interlace.

Aspect 16: The method of Aspect 15, wherein duplicating the PF2 resource DMRS comprises duplicating the PF2 resource DMRS and one or more data resource elements on the one or more remaining interleaved resource blocks within the same interlace or the common interlace.

Aspect 17: The method of Aspect 15, further comprising transmitting a PF2 resource based bandwidth padding signal.

Aspect 18: The method of Aspect 17, wherein a waveform associated with the PF2 resource based bandwidth padding signal is based at least in part on a repetition of a PF2 resource DMRS on one or more remaining interleaved resource blocks in a resource block set having a reserved OCC index.

Aspect 19: The method of Aspect 17, wherein a waveform associated with the PF2 resource based bandwidth padding signal is based at least in part on a repetition of a PF2 resource DMRS and one or more data resource elements on one or more remaining interleaved resource blocks in a resource block set having a reserved OCC index.

Aspect 20: The method of Aspect 17, wherein the PF2 resource based bandwidth padding signal occupies a dedicated common interlace of one or more interlaces associated with the PF2 resource.

Aspect 21: The method of Aspect 17, wherein the PF2 resource based bandwidth padding signal occupies a same interlace as an acknowledgement message that uses an interlace associated with the PF2 resource.

Aspect 22: The method of Aspect 17, wherein radio resource control (RRC) information indicates whether to transmit the PF2 resource based bandwidth padding signal.

Aspect 23: The method of Aspect 22, wherein the RRC information that indicates whether to transmit the PF2 resource based bandwidth padding signal indicates whether to transmit the PF2 resource based bandwidth padding signal based at least in part on a region, a regulation, or a band.

Aspect 24: A method of wireless communication performed by a network node, comprising: identifying a number of interleaved resource blocks to be used by a plurality of physical sidelink feedback channel (PSFCH) resources, the plurality of PSFCH resources including at least a first PSFCH resource that occupies a first number of interleaved resource blocks within an interlace and a second PSFCH resource that occupies a second number of interleaved resource blocks within the interlace, the first number of interleaved resource blocks and the second number of interleaved resource blocks being contiguous or configured in accordance with an interval; and transmitting configuration information that indicates the number of interleaved resource blocks to be used by the plurality of PSFCH resources.

Aspect 25: The method of Aspect 24, wherein the first PSFCH resource is configured to be used by a first UE and the second PSFCH resource is configured to be used by a second UE.

Aspect 26: The method of any of Aspects 24-25, wherein transmitting the configuration information comprises transmitting radio resource control information that includes the configuration information.

Aspect 27: The method of any of Aspects 24-26, wherein transmitting the configuration information comprises transmitting sidelink control information that includes the configuration information.

Aspect 28: The method of any of Aspects 24-27, wherein at least one of the first PSFCH resource and the second PSFCH resource is a PSFCH format 2 resource.

Aspect 29: The method of any of Aspects 24-28, wherein the first PSFCH resource and the second PSFCH resource occupy different frequency domain orthogonal cover codes.

Aspect 30: The method of any of Aspects 24-29, wherein a portion of the first PSFCH resource and a portion of the second PSFCH resource occupy different interlaces.

Aspect 31: The method of any of Aspects 24-30, wherein the first PSFCH resource and the second PSFCH resource occupy different contiguous interleaved resource blocks within the interlace.

Aspect 32: The method of any of Aspects 24-31, wherein the first PSFCH resource is a PSFCH format 2 (PF2) resource and the second PSFCH resource is a PSFCH format 0 (PF0) resource, and wherein the PF2 resource and the PF0 resource are multiplexed in different interlaces using frequency division multiplexing.

Aspect 33: The method of Aspect 32, wherein the configuration information indicates to transmit a bandwidth padding signal associated with the PF2 resource and the PF0 resource using a common interlace.

Aspect 34: The method of Aspect 33, wherein the configuration information indicates to transmit a bandwidth padding signal, that is based at least in part on the PF0 resource, using a reserved cyclic shift resource in the common interlace.

Aspect 35: The method of Aspect 32, wherein the configuration information indicates to assign one frequency division (FD) orthogonal cover code (OCC) resource as a reserved OCC resource, to transmit an acknowledgement message carrying a PF2 resource interlace, and to duplicate a PF2 resource demodulation reference signal (DMRS) on one or more remaining interleaved resource blocks within a same interlace or a common interlace.

Aspect 36: The method of Aspect 35, wherein the configuration information further indicates to transmit a PF2 resource based bandwidth padding signal.

Aspect 37: The method of Aspect 36, wherein the configuration information indicates that the PF2 resource based bandwidth padding signal is to occupy a dedicated common interlace of one or more interlaces associated with the PF2 resource.

Aspect 38: The method of Aspect 36, wherein the configuration information indicates that the PF2 resource based bandwidth padding signal is to occupy a same interlace as an acknowledgement message that uses an interlace associated with the PF2 resource.

Aspect 39: The method of Aspect 36, wherein the configuration information indicates whether to transmit the PF2 resource based bandwidth padding signal based at least in part on a region, a regulation, or a band.

Aspect 40: An apparatus for wireless communication at a device, comprising a processor, memory coupled with the processor, and instructions stored in the memory and executable by the processor to cause the apparatus to perform the method of one or more of Aspects 1-39.

Aspect 41: A device for wireless communication, comprising a memory and one or more processors coupled to the memory, the one or more processors configured to perform the method of one or more of Aspects 1-39.

Aspect 42: An apparatus for wireless communication, comprising at least one means for performing the method of one or more of Aspects 1-39.

Aspect 43: A non-transitory computer-readable medium storing code for wireless communication, the code comprising instructions executable by a processor to perform the method of one or more of Aspects 1-39.

Aspect 44: A non-transitory computer-readable medium storing a set of instructions for wireless communication, the set of instructions comprising one or more instructions that, when executed by one or more processors of a device, cause the device to perform the method of one or more of Aspects 1-39.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example. “at least one of: a, b, or c” is intended to cover a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having.” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM. CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

1. A method of wireless communication performed by a user equipment (UE), comprising:
receiving configuration information that indicates a number of interleaved resource blocks to be used by a plurality of physical sidelink feedback channel (PSFCH) resources, the plurality of PSFCH resources including at least a first PSFCH resource that occupies a first number of interleaved resource blocks within an interlace and a second PSFCH resource that occupies a second number of interleaved resource blocks within the interlace, the first number of interleaved resource blocks and the second number of interleaved resource blocks being contiguous or configured in accordance with an interval; and
transmitting a PSFCH communication via at least one of the first PSFCH resource or the second PSFCH resource.

2. The method of claim 1, wherein the first PSFCH resource is configured to be used by the UE and the second PSFCH resource is configured to be used by another UE.

3. The method of claim 1, wherein at least one of the first PSFCH resource and the second PSFCH resource is a PSFCH format 2 resource.

4. The method of claim 1, wherein the first PSFCH resource and the second PSFCH resource occupy different frequency domain orthogonal cover codes.

5. The method of claim 1, wherein a portion of the first PSFCH resource and a portion of the second PSFCH resource occupy different interlaces.

6. The method of claim 1, wherein the first PSFCH resource and the second PSFCH resource occupy different contiguous interleaved resource blocks within the interlace.

7. The method of claim 1, further comprising receiving radio resource control (RRC) information or sidelink control information (SCI) that indicates the plurality of PSFCH resources and that indicates to use a hashing function to select a PSFCH resource of the plurality of PSFCH resources, wherein the hashing function is based at least in part on a number of orthogonal cover codes or a number of resources in the plurality of PSFCH resources, and at least one of a transmitter identifier or a groupcast identifier.

8. The method of claim 1, wherein the first PSFCH resource is a PSFCH format 2 (PF2) resource and the second PSFCH resource is a PSFCH format 0 (PF0) resource, and wherein the PF2 resource and the PF0 resource are multiplexed in different interlaces using frequency division multiplexing.

9. The method of claim 8, further comprising transmitting a bandwidth padding signal associated with the PF2 resource and the PF0 resource using a common interlace, wherein the bandwidth padding signal is based at least in part on the PF0 resource and is transmitted using a reserved cyclic shift resource in the common interlace, and wherein the common interlace is a single reserved interlace in the PF0 resource that is reserved for the bandwidth padding signal.

10. The method of claim 9, wherein the bandwidth padding signal is transmitted via the reserved cyclic shift resource, and wherein an acknowledgement signal carrying a PF0 resource transmission is multiplexed with other cyclic shift resources in the common interlace.

11. The method of claim 9, further comprising dropping an interleaved resource block associated with the common interlace based at least in part on the interleaved resource block associated with the common interlace being located within a number of resource blocks from one or more interleaved resource blocks associated with the PF2 resource.

12. The method of claim 8, wherein the configuration information indicates to assign one frequency division (FD) orthogonal cover code (OCC) resource as a reserved OCC resource, and wherein the UE is configured to transmit an acknowledgement message carrying a PF2 resource interlace and to duplicate a PF2 resource demodulation reference signal (DMRS) on one or more remaining interleaved resource blocks within a same interlace or a common interlace.

13. The method of claim 12, wherein duplicating the PF2 resource DMRS comprises duplicating the PF2 resource DMRS and one or more data resource elements on the one or more remaining interleaved resource blocks within the same interlace or the common interlace.

14. The method of claim 12, further comprising transmitting a PF2 resource based bandwidth padding signal.

15. The method of claim 14, wherein a waveform associated with the PF2 resource based bandwidth padding signal is based at least in part on a repetition of a PF2 resource DMRS on one or more remaining interleaved resource blocks in a resource block set having a reserved OCC index.

16. The method of claim 14, wherein a waveform associated with the PF2 resource based bandwidth padding signal is based at least in part on a repetition of a PF2 resource DMRS and one or more data resource elements on one or more remaining interleaved resource blocks in a resource block set having a reserved OCC index.

17. The method of claim 14, wherein the PF2 resource based bandwidth padding signal occupies a dedicated common interlace of one or more interlaces associated with the PF2 resource.

18. The method of claim 14, wherein the PF2 resource based bandwidth padding signal occupies a same interlace as an acknowledgement message that uses an interlace associated with the PF2 resource.

19. The method of claim 14, wherein radio resource control (RRC) information indicates whether to transmit the PF2 resource based bandwidth padding signal based at least in part on a region, a regulation, or a band.

20.-28. (canceled)

29. An apparatus for wireless communication at a user equipment (UE), comprising:
a memory; and
one or more processors, coupled to the memory, configured to:
receive configuration information that indicates a number of interleaved resource blocks to be used by a plurality of physical sidelink feedback channel (PSFCH) resources, the plurality of PSFCH resources including at least a first PSFCH resource that occupies a first number of interleaved resource blocks within an interlace and a second PSFCH resource that occupies a second number of interleaved resource blocks within the interlace, the first number of interleaved resource blocks and the second number of interleaved resource blocks being contiguous or configured in accordance with an interval; and
transmit a PSFCH communication via at least one of the first PSFCH resource or the second PSFCH resource.

30. (canceled)
